(19) United States
(12) Patent Application Publication
(10) Pub. No.: US 2019/0385095 A1
(43) Pub. Date: Dec. 19, 2019

(54) Office Resource Management and Allocation

(71) Applicant: Senion AB, Linkoping (SE)

(72) Inventors: Jonas P.G. Callmer, Stockholm (SE); Tim C.A. Bjärengren, Linkoping (SE); Anton H. Birch-Tyrberg, Linkoping (SE)

(73) Assignee: Senion AB, Linkoping (SE)

(21) Appl. No.: 16/007,699

(22) Filed: Jun. 13, 2018

(51) Int. Cl. G06Q 10/02; H04W 4/02; H04L 29/08

(52) U.S. Cl. CPC G06Q 10/02; G06Q 10/1093; H04L 67/18; H04W 4/02

(57) ABSTRACT

An office system for improving workplace resource usage includes multiple application instances implemented on multiple mobile electronic communication devices, associated with office occupants. The application is configured to determine a device user's location and, to execute an action based on the device user's location. The application may also access the user's calendar. In response to this data, the application may engage in communications and tasks to improve efficiency, such as asking the user if they would like cancel a meeting that the user may be unable to make, as well as affirmatively reserving and releasing office resource such as meeting rooms when user context so indicates.

### TECHNICAL FIELD

The present disclosure is related generally to office resource management and, more particularly, to a system and method for efficiently and seamlessly integrating external data and internal resource information to allocate office resources.

### BACKGROUND

Currently, the management of office resources is sometimes intrusive, sometimes ineffective, and rarely efficient. For example, office occupants may reserve a meeting room for a time when they may not even be in the same town as the meeting. Similarly, reserved meeting rooms are rarely cancelled if a meeting is cancelled, leading to an artificial shortage of resources. Moreover, it is difficult to have gatherings on short notice due to the inflexibility of many reservation systems.

In general, office resource allocation inefficiencies occur in a handful of categories including searching for resources, reserved resources that go unused and unknown utilization of office spaces.

Before proceeding, it should be appreciated that the present disclosure is directed to a system that may address some of the shortcomings listed or implicit in this Background section. However, any such benefit is not a limitation on the scope of the disclosed principles, or of the attached claims, except to the extent expressly noted in the claims.

Additionally, the discussion of technology in this Background section is reflective of the inventors' own observations, considerations, and thoughts, and is in no way intended to accurately catalog or comprehensively summarize any prior art reference or practice. As such, the inventors expressly disclaim this section as admitted or assumed prior art. Moreover, the identification herein of one or more desirable courses of action reflects the inventors' own observations and ideas, and should not be assumed to indicate an art-recognized desirability.

### SUMMARY

In an embodiment of the disclosed principles, a personal office assistant app (software application) for smartphones is provided. The app may be installed on a number of smartphones employed by a number of individuals, e.g., office employees, campus members, etc. who use a common building or other bounded location. The app associated with each user maintains and updates information relating to user ID, user location, user calendar and time, and is configured to execute many routine tasks for each user. As used herein, the term “office occupant” is intended to refer to all such associated individuals whether physically present in an office or remote from the office, such as may be the case with a travelling individual.

A positioning system associated with the app and the smartphone automatically starts the app when the device (and its user) enters the office or other designated location. In another embodiment, the app may remain on but idle outside of the designated area, and may be triggered to act by an event, such as a calendar event, incoming data, such as location data associated with another user, or other occurrence.

The app provides assistance with routine tasks such as meeting with office occupants, locating meeting rooms, reserving and releasing meeting rooms (tasks referred to herein as “reservation tasks”), and more. At the same time, the app may assist management with the generation of information as to the manner in which office resources are being used. The app provides management of office resources via smart data access and inferences. This includes meeting room bookings, modifications and releases based on location, host calendar and so on, as well as meeting cancellations, booking room on entry and so on. In the course of executing various tasks, the app may query the user and receive input from the user.

In an embodiment, tasks are pushed or suggested by the app. That is, the app may prompt the user as to suggested tasks via a notification, requiring just a simple interaction by the user. In this way, user approval can be given, or withheld, without requiring the user to unlock the device and open the app.

Other features and aspects of the disclosed principles will be apparent from the detailed description taken in conjunction with the included figures.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a simplified schematic view of a device environment within which various embodiments of the disclosed principles may be implemented;

FIG. 2 is a device screen view according to an embodiment of the described principles, wherein the user is notified of room availability;

FIG. 3 is a device screen view according to an embodiment of the described principles, showing the user relative to the meeting room;

FIG. 4 is a device screen view according to an embodiment of the described principles, wherein the user is prompted to cancel a meeting if the user's attendance is impossible or unlikely;

FIG. 5 is a device screen view according to an embodiment of the described principles, showing an example screen presented when a meeting ends early;

FIG. 6 is a device screen view according to an embodiment of the described principles, showing an example set of displays when a user's location is requested;

FIG. 7 is a device screen view according to an embodiment of the described principles, showing a notification that a room is available, and asking whether the user would like to book the room;

FIG. 8 is a device screen view according to an embodiment of the described principles, showing an example display allowing the device user to more efficiently meet with office occupants;

FIG. 9 shows an example of feedback to management from apps in use regarding facilities usage in accordance with an embodiment of the described principles; and

FIG. 10 is a more detailed schematic view of a device such as device 200 as well as its context and internal functional modules.

### DETAILED DESCRIPTION

As noted above, modern management of office resources is generally intrusive and inefficient. Space is wasted when it is reserved and then not used, and this factor manifests as an artificial shortage of resources. Moreover, it is difficult to have gatherings on short notice due to the inflexibility of current reservation systems. In general, office resource allocation inefficiencies occur in the context of locating appropriate resources, reserving resources and monitoring for potential disuse of reserved resources.

Turning to the disclosed inventive concepts, in an example embodiment, the app hosted on the user's mobile device, e.g., smartphone detects that the user is entering a meeting room or other reservable facility, and in response, the app books the room for the user. Similarly, meeting reminders may account for user context, such as location, to be more helpful. For example, if the user's location is a long distance from the location required for a scheduled meeting, the app may provide an earlier reminder, and perhaps a note that the user needs to allow extra time to travel to the meeting.

If the distance is too great for the user to be able to make it back for the meeting, the app may automatically release the reservation when that fact becomes apparent. For example, if the user is an hour away from the office where a meeting is to be hosted by the user, and the meeting is scheduled to begin in 15 minutes, the app may cause a notification to appear on the device screen, asking if the user would like to cancel the meeting and/or the facility reservation. Alternatively, the app may proactively cancel the meeting, and in an embodiment may also send meeting cancellation notifications to scheduled participants. More generally, meeting reminders provided by the app can be based on where the user is and where the user is scheduled to go.

In another example, a meeting hosted by the user may end sooner than expected. The app may detect this fact, for example, by utilizing the user's location when the user leaves the meeting room and fails to reenter within a predetermined period of time. In this situation, the app may end the reservation early as well, freeing the room up for other users. In an embodiment, the app provides a notification to the user asking if the user would like to release the reservation.

To aid in convenience, all or most of the interactions with the app by the user are performed from the device lock screen in an embodiment of the disclosed principles. These micro-interactions allow the user to execute actions without even opening the app. For example, for most confirmations, a simple tap on the device screen will be sufficient.

As office occupants use the app, anonymized occupancy data is collected in real-time. In this way, management is able to get a better understanding of room use type, extent and frequency. In a further embodiment, anonymized location data may be provided, e.g., to make management personnel aware of the facility occupancy patterns and identify well-used, unused or underused areas.

In a number of embodiments, as discussed above, user location is important information for the app to operate. This location data may be gathered in background mode by another app or a portion of the same app. In an example, the location is generated via a combination of inertial measurement, external location cues and dead reckoning. External location cues may include WiFi access points, near field emitters, known audio cues, known building architecture matching and, when available, GPS tracking.

While different systems may serve the need to identify location, it is preferable that any such system to be accurate at least at the level of individual rooms, so as to allow for the app's meeting functionalities. The positioning logic may launch whenever the device enters the office or other relevant space, such as a remote office.

To ensure integrity, the app, in an embodiment, follows a set of privacy guidelines. These may include, for example, never sharing personal location data without the user's consent, never sharing location data with third parties and ensuring that the use of location data is relevant and minimal. To further enhance privacy, the user location is only computed on the phone.

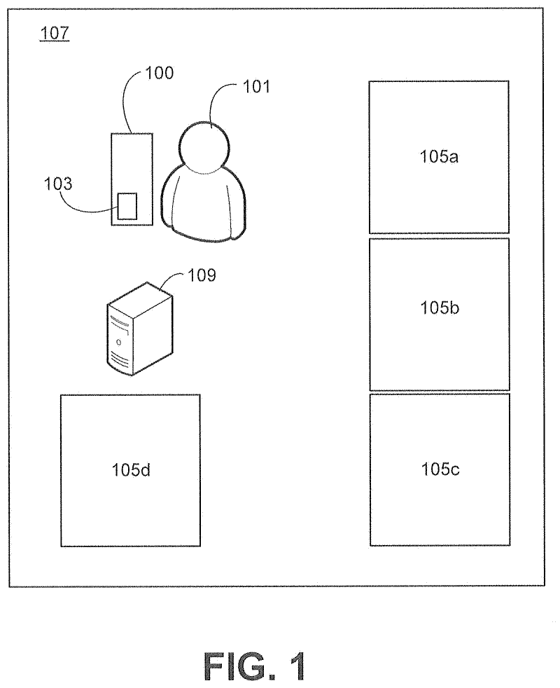

The attached figures provide a visualization of various aspects and embodiments of the described principles, and may clarify the foregoing examples. Turning to FIG. 1, this figure shows a device environment in which various embodiments of the described principles may be implemented. In the illustrated figure, which is simplified to omit that which is commonly known, the device 100 is shown associated with a user 101. These two 100, 101 are assumed to move as an entity, as will generally be the case. The device 100, via the app 103, maintains an awareness of the device's location in relation to other relevant locations such as meetings rooms 105 and the building 107.

The app 103 may communicate directly or indirectly with a building server 109, which may be local or remote, to make and release reservations. The app 103 may also communicate with a mail application of the device 100 or with a mail server to gather user calendar information for meeting awareness. The app 103 may communicate with any number of facilities for purposes such as positioning. For example, the app 103 may access a database of building plans to help with positioning and with meeting room awareness. In addition, the app 103 may communicate with onboard inertial sensors as well as external sensors or positioning systems, e.g., GPS, to aid with positioning.

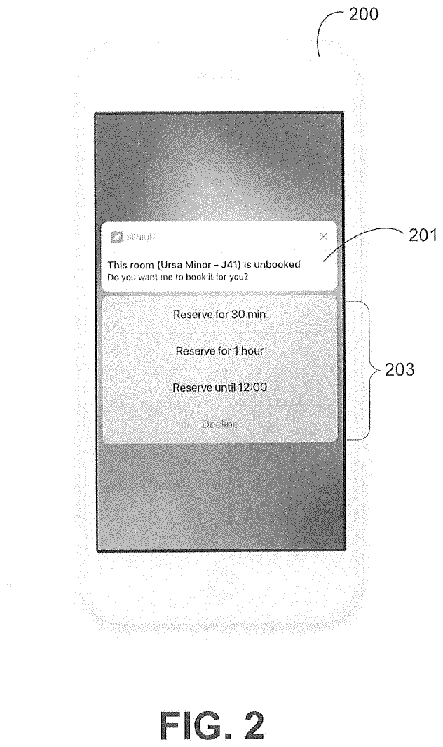

Turning to FIG. 2, this figure illustrates an example of a low-user-effort assist from the app, triggered when the user (and device) entered a particular meeting room. The illustrated example shows the user device 200 and contains a notification field 201 informing the user that the meeting room is currently unbooked. The device screen also shows selectable user options 203 for booking the room, including options for 30 minutes, 1 hour and an end time (12:00). An option to decline is also presented.

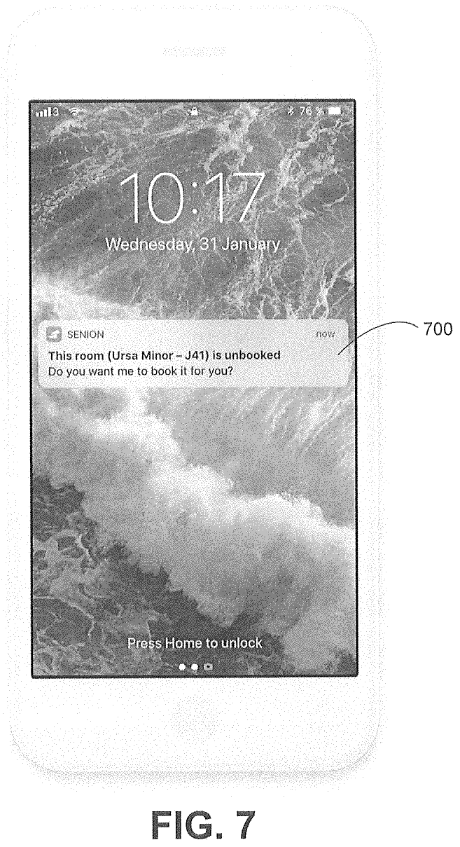

An alternative example screen (relative to that of FIG. 2) shown during this process is illustrated in FIG. 7. As shown the device display includes a notification 700 indicating that the room just entered is available, and asking whether the user would like to book the room.

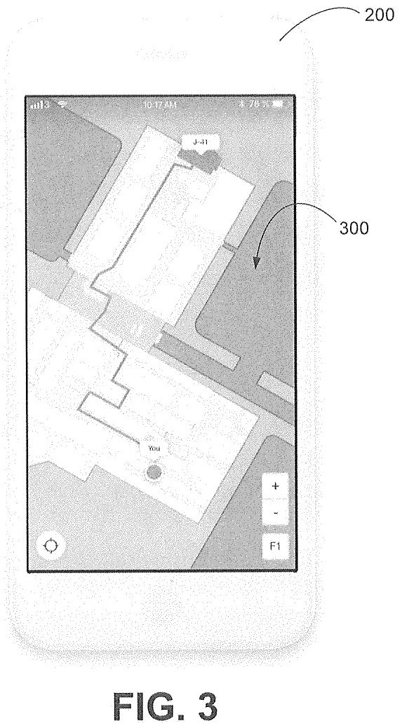

Similarly, FIG. 3 shows a device screen view 300 triggered by the user's location and the location of the meeting room for an upcoming meeting. The location view shows the user relative to the meeting room, and may provide the user with an option (not shown) to cancel the meeting if indicated by the user's distance from the room.

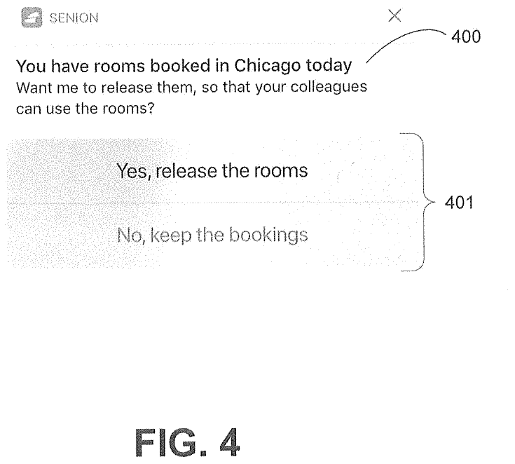

FIG. 4 shows an example of the functionality described above, wherein the app may prompt the user to cancel a meeting if the user location relative to the meeting location (e.g., in another city or country) makes attendance impossible or unlikely. Thus in the illustrated view, the device screen provides a reminder 400 of the meeting, which also notes that attendance is unlikely by asking if the user would like to have the meeting cancelled. An option field 401 provides selectable response options, i.e., “yes, release the room” and “no, keep the booking.” A user might choose the latter, for example, if other attendees will still be able to hold the meeting.

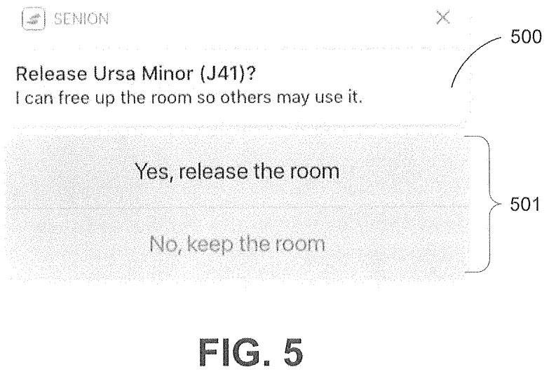

Turning to FIG. 5, this figure shows an example screen display presented when a meeting ends early, as shown by the user leaving the room. Without the app described herein, the room will likely remain unavailable to others even though the meeting ended early. However, with the app, a screen display is presented containing a notification 500 asking if the user will be returning to the meeting room, and, if not, would the user like to release the reservation. The display also includes a selectable option field 501 wherein the user may select how to respond. In the illustrated embodiment, the user's options in the option field 501 are to release the room or to keep the room.

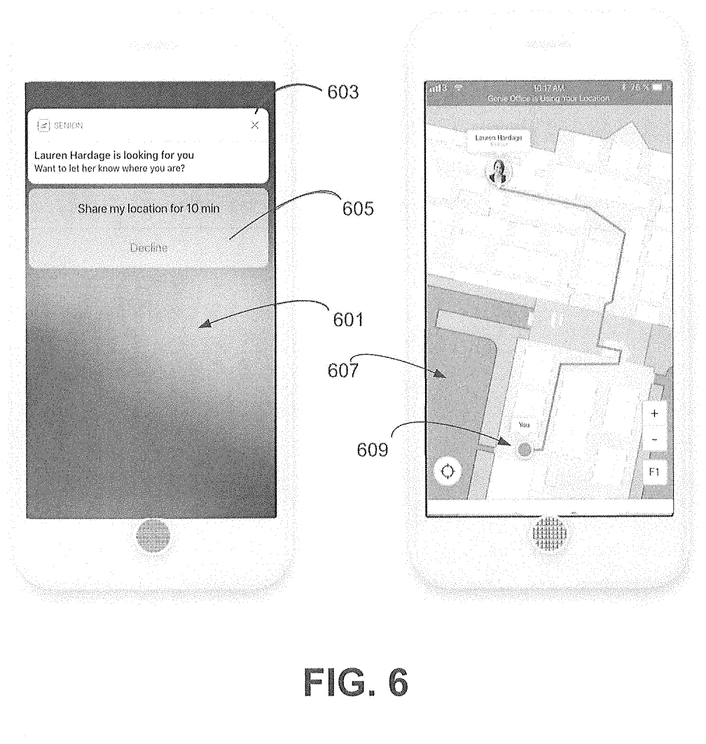

FIG. 6 shows an example set of displays when a user's location is requested. In this case, the first screen 601 contains a notification field 603 alerting the user that another user is looking for the first user, and asking if the user would like to share their location with the other user. The display 601 also includes a selectable option field 605 wherein the user may select how to respond. The presented options are “Share my location for 10 minutes” and “Decline.” If the latter is selected, the user's location is not shared. In the event that the user chooses the first option, the second screen view 607 shows the first user a map view 609 of the other user's location. Alternatively, both users are shown each other's locations.

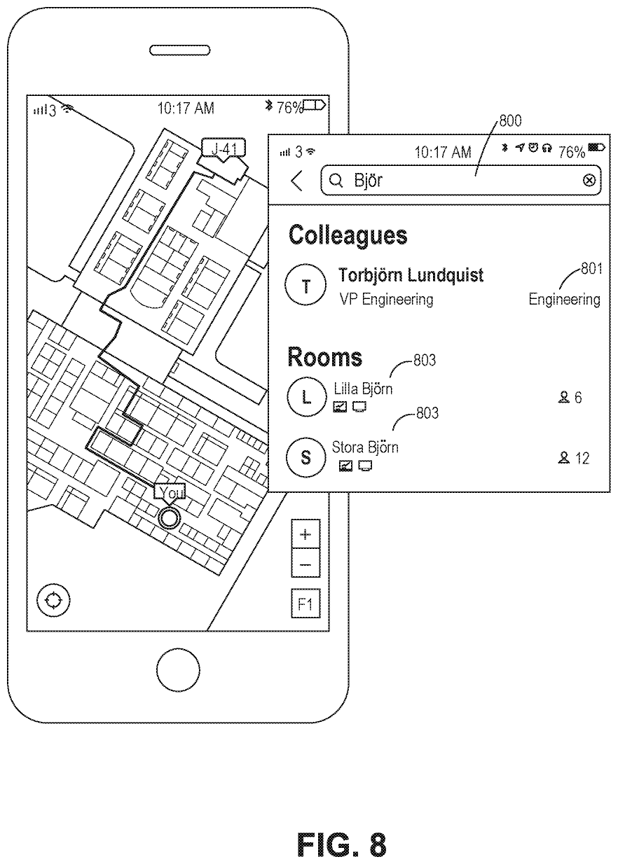

FIG. 8 shows an example screen allowing the device user to more efficiently meet with office occupants. In the illustrated example, the device display includes a notification window 800. The window 800 includes an office occupants field 801 and a rooms field 803. In this way, the user can search for one or more office occupants or search for a meeting room. In a further embodiment, the user may use this screen to select a convenient and available meeting room, and to select desired attendees, after which the system automatically books the room and sends invitations to the potential attendees.

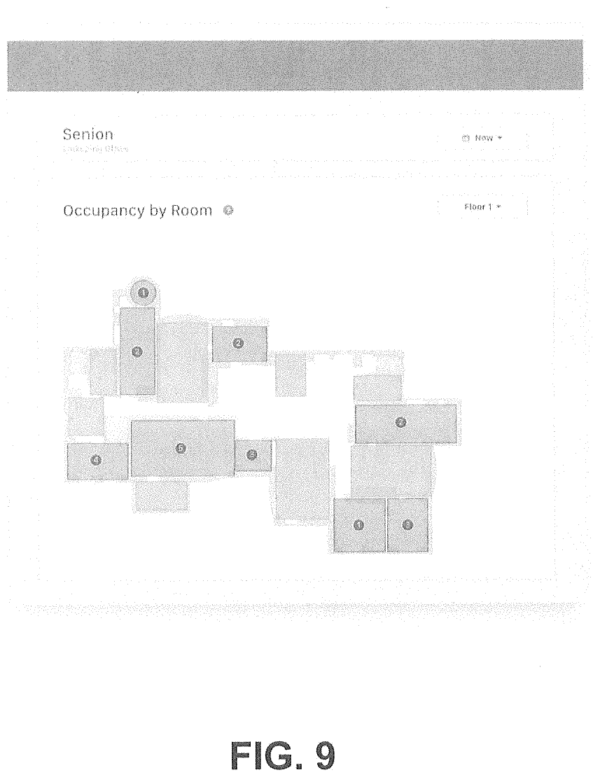

FIG. 9 shows an example of feedback to management from the apps in use regarding facilities usage. In the illustrated embodiment, rooms are shown in green and red to indicate different levels of usage, i.e., the number of users in the room over time. As noted above, the location data is anonymized and is collected in real-time as office occupants use the app.

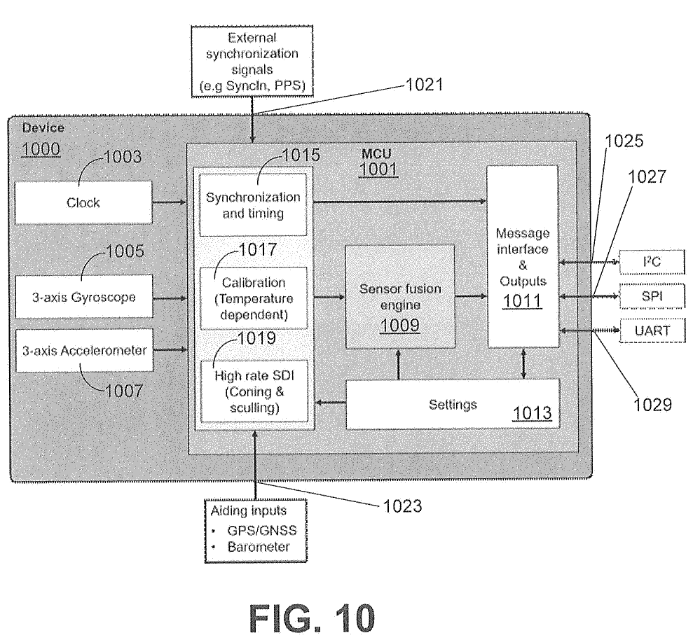

FIG. 10 is a more detailed schematic view of a device such as device 200, within which various embodiments of the disclosed principles may be implemented. The illustrated device 1000 (200) is comprised of a number of components. These include a microcontroller unit (MCU) 1001, as well as basic modules such as a 3-axis gyroscopic sensor 1005, a 3-axis accelerometer 1007 and a clock 1003. The MCU 1001 also includes several inputs including input 1021 for receiving external synchronization signals and input 1023 for receiving aiding information, e.g., from a GPS, GNSS, barometer, gravitometer, etc.

The MCU 1001 also supports one or more of various data links including an I2C protocol link 1025, a serial peripheral interface (SPI) protocol link 1027 and a universal asynchronous receiver-transmitter (UART) link 1029. As those of skill in the art will appreciate, any suitable additional communication infrastructure not shown may also be used. For example, the device 200 may support BLUETOOTH communications, near field communications, wired communications such as Ethernet, and so on.

In the illustrated example, the heart of the MCU 1001 is a sensor fusion engine 1009, which is used to derive position and orientation increments in an embodiment. Other internal modules of the MCU 1001 include modules for synchronization and timing 1015, calibration 1017, high rate SDI 1019, message interface and outputs 1011, and settings 1013. It is contemplated that devices usable within embodiments of the disclosed principles may use other device configurations. For examples, devices having different types and numbers of modules may still be used to implement various embodiments.

Various systems and processes have been disclosed herein. However, in view of the many possible embodiments to which the principles of the present disclosure may be applied, it should be recognized that the embodiments described herein are meant to be illustrative only and should not be taken as limiting the scope of the claims. Therefore, the techniques as described herein contemplate all such embodiments as may come within the scope of the following claims and equivalents thereof.

We claim:

1. An office system comprising:
a plurality of mobile electronic communication devices, each mobile electronic communication device being associated with a device user, the device users being associated with a business location; and
an application running on each of the plurality of mobile electronic communication devices, the application being configured to determine a device user's location and, to take an action based on the device user's location, the action being either or both of issuing a communication to the device user and performing a task relative to the device user and a business location resource.

2. The office system in accordance with claim 1, wherein the application is further configured to access the device user's calendar.

3. The office system in accordance with claim 1, wherein the app suggests the action to the user and wherein the user approves, declines or alters the action.

4. The office system in accordance with claim 1, wherein the actions include resource booking, resource unbooking and reminders.

5. The office system in accordance with claim 1, wherein the communication is executed as a notification by the application.

6. The office system in accordance with claim 3, wherein the user interaction is performed as a notification interaction on the device lock screen.

7. The office system in accordance with claim 4, wherein a resource unbooking is suggested if the user location and time indicate that utilization of the resource is unlikely.

8. The office system in accordance with claim 4, wherein the resource is a meeting room.

9. The office system in accordance with claim 8, wherein a meeting room booking is suggested when the user location indicates that they have entered an available room.

10. The office system in accordance with claim 2, wherein the application is further configured to perform a scheduling task based on the device user's location and calendar.

11. The office system in accordance with claim 10, wherein the scheduling task comprises altering a reminder schedule based on the device user's location, the current time, and the time and location of an upcoming meeting.

12. The office system in accordance with claim 2, wherein the application is further configured to determine that an ongoing meeting is ending sooner than scheduled and in response to take an action selected from the group consisting of issuing a communication to the device user and performing a reservation task relative to both the device user and a workplace resource.

13. The office system in accordance with claim 12, wherein the communication to the device user comprises a query as to whether the device user would like to release the resource.

14. The office system in accordance with claim 12, wherein the reservation task comprises releasing the resource.

15. The office system in accordance with claim 14, wherein the resource is a meeting room.

16. A method of managing office resources comprising:
determining a person's location relative to a known location using a mobile device associated with the person; and
executing an action based on the device user's location relative to the known location, wherein the executed action comprises performing a task relative to the device user and an office resource associated with the known location.

17. The method in accordance with claim 16, further comprising accessing the person's calendar via the mobile device associated with the person.

18. The office system in accordance with claim 16, wherein the app suggests the action to the user and wherein the user approves, declines or alters the action.

19. The office system in accordance with claim 16, wherein the actions include resource booking, resource unbooking and reminders.

20. The office system in accordance with claim 19, wherein the resource is a meeting room.
